(19) United States
(12) Patent Application Publication
(10) Pub. No.: US 2005/0028685 A1
(43) Pub. Date: Feb. 10, 2005

(54) Vegetable retainer for vegetable cooking utensil

(76) Inventor: Hajime Yamamoto, Iwakuni-shi (JP)

Correspondence Address: Paul A. Fattibene;Fattibene and Fattibene, 2480 Post Road, Southport, CT, 06890, US

(21) Appl. No.: 10/634,100

(22) Filed: Aug. 4, 2003

(51) Int. Cl. A23N 1/00

(52) U.S. Cl. 99/537

(57) ABSTRACT

In a vegetable retainer employed for a vegetable cooling utensil which is provided with a flat blade and a comb blade on a roughly central portion in a longitudinal direction of a vegetable cooking utensil main body of a roughly rectangle in a plan view to shred a vegetable and the like, in order that the vegetable retainer can be held reliably and that a finger tip is prevented from coming into contact with a cooking blade so that safety performance is improved, the vegetable retainer comprises an approximately flat plate-like retainer main body portion whose central portion underside is recessed to form a recess, a vegetable retaining portion which protrudes from the recess and which is constructed of a plurality of comb teeth bodies for being stuck into a vegetable and the like to retain it, sliding portions which extend vertically on both side portions of the retainer main body portion and which are guided by both side portions of the vegetable cooking utensil main body to slide, and a holding portion which extends upwardly from an upper surface of the retainer main body portion and by which a cooking person holds the vegetable retainer.

### BACKGROUND OF THE INVENTION

1. Field of the Invention

The present invention relates to a vegetable retainer for a vegetable cooking utensil and in particular to a vegetable retainer for a vegetable cooking utensil in which holding a vegetable holder can be performed reliably and safety performance is improved by preventing a finger tip from projecting and from coming into contact with a cooking blade in a vegetable retainer employed for a vegetable cooking utensil constructed by comprising a flat blade and a comb blade so as to shred vegetables and the like.

2. Description of the Prior Art

This conventional type of vegetable cooking utensil will be explained according to FIGS. 5 to 14. The present applicant has already filed a patent application regarding this conventional type of vegetable cooking utensil (refer to Patent Document 1), and this vegetable cooking utensil will be explained according to FIGS. 5 to 10. In FIG. 5, the reference numeral 1 denotes a vegetable cooking utensil, and this vegetable cooking utensil 1 consists of a vegetable cooking utensil main body 2 which is made of a hard synthetic resin formed into a roughly rectangle in a plan view, a metal flat blade 3 which is removably attached to the vegetable cooking utensil main body 2, and a metal comb blade 4 which is removably attached parallel to the flat blade 3. The vegetable cooking utensil main body 2 consists of left and right frame parts 5, 5 provided to be spaced apart at a predetermined space, a reception plate 6 fixed on a front half portion (a left half portion in the drawing) between the left and right frame parts 5, 5, a regulating reception plate 7 rotatably arranged on a rear half portion (a right half portion in the drawing) between the left and right frame parts 5, 5, and a graspable holding body 8 which is arranged across the left and right frame parts 5, 5 so as to couple them on a rear end portion of the left and right frame parts 5, 5.

Further, the vegetable cooking utensil main body 2 has grooves 9, 9 which are oppositely disposed in a diagonal direction and which are drilled in a horizontal direction on approximately central portions in the longitudinal direction of the left and right frame parts 5, 5, so that the flat blade 3 shown in FIG. 6 is inserted from one of the grooves 9, 9 so that both end portions 3a, 3a of the flat blade 3 are positioned on the grooves 9, 9 and a middle part of the flat blade 3 is supported in a removable way on a step portion 6a which is formed on a rear end of the reception plate 6.

The vegetable cooking utensil main body 2 is constructed so that the flat blade 3 can be fixed on the grooves 9, 9 by providing screw tubes 10, 10 on positions which are on undersides of the left and right frame parts 5, 5 and on positions of the grooves 9, 9 as shown in FIG. 7, screwing respective screws 11, 11 from the undersides of the screw tubes 10, 10, and pressing the flat blade 3 against upper wall surfaces of the grooves 9, 9 while pressing both respective end portions of the flat blade 3 by distal end portions of the screws 11, 11.

The comb blade 4 is juxtaposed with the flat blade 3 so as to be perpendicular to the flat blade 3 while being spaced apart from the flat blade 3 at a predetermined space, and the comb blade 4 is disposed across the left and right frame parts 5, 5 and is fixed by means of comb blade fixing screws 12, 12 which are screwed from side portions of the left and right frame parts 5, 5 toward the inner side.

Further, as shown in FIG. 8, pivot pins 13, 13 protrude on rear end portions of the side portions of the regulating reception plate 7, while as shown in FIG. 9, pivot grooves 14, 14 which are opened to the inner side and rear sides of the left and right frame parts 5, 5 are formed on rear ends of the left and right frame parts 5, 5 so that the pivot pins 13, 13 of the regulating reception plate 7 are inserted into the pivot grooves 14, 14.

Moreover, the vegetable cooking utensil main body 2 is constructed so that shredding thickness of a vegetable can be changed by providing a stay 15, which is disposed across the left and right frame parts 5, 5, on an underside of the regulating reception plate 7 as shown in FIG. 7, by screwing a regulation screw 16 from an underside on a central portion of the stay 15 so that a distal end of the regulation screw 16 removably supports the bottom surface of the regulating reception plate 7, and by varying screwing amount of the regulation screw 16 so that respective protruding lengths of the comb blade 4 and the flat blade 3 protruding upwardly from a sliding movement guiding surface that is the upper surface of the regulating reception plate 7 are regulated.

As shown in FIG. 10, protruding portions 17, 17 which protrude forwardly are formed near both end portions of the front surface of the holding body 8, and holes 18, 18 extending vertically are drilled in the protruding portions 17, 17 while holding body fixing holes 19, 19 are threaded on rear ends of the left and right frame parts 5, 5 shown in FIG. 9. After the pivot pins 13, 13 are inserted into the pivot grooves 14, 14, the protruding portions 17, 17 provided on the holding body 8 are inserted so that positioning of the holes 18, 18 drilled in the protruding portions 17, 17 and the holding body fixing holes 19, 19 are performed. Thereafter, screws 20, 20 shown in FIG. 5 are screwed into the holding body fixing holes 19, 19 and the holes 18, 18 of the protruding portions 17, 17 to fix the holding body 8.

Thus, rear end opening portions 14a, 14a of the pivot grooves 14, 14 are closed by the protruding portions 17, 17, and detachment of the pivot pins 13, 13 is restricted, and as a result, the regulating reception plate 7 can vertically rotate, taking the pivot pins 13, 13 as supporting points of the rotation.

When a vegetable or the like is cooked while being slidingly rubbed with the upper surfaces of the reception plate 6 and the regulating reception plate 7, the comb blade 4 scores, and long, thin shredded pieces sliced by the flat blade 3 fall from a gap between the edges of the comb blade 4 and the flat blade 3. It is also possible to remove the comb blade 4 and use only the flat blade 3. In this case, belt-like thin pieces can be obtained.

In FIG. 11, the reference numeral 21 denotes a vegetable retainer for a vegetable cooking utensil which has been practically employed for the vegetable cooking utensil 1 though it is not described in Patent Document 1. In cases where a vegetable and the like is cooked while being slidingly rubbed with the upper surfaces of the reception plate 6 and the regulating reception plate 7, employing the vegetable cooking utensil 1, when the vegetable and the like is shredded/cooked and becomes small or thin, or the like, the vegetable retainer 21 is to retain a vegetable and the like for the sake of safety of a cooking person. When a cooking person allows the vegetable retainer 21 to retain a vegetable and the like and slide it on the vegetable cooking utensil main body 2, the safety of the cooking person is attained, and the vegetable and the like can be shredded/cooked without waste.

As shown in FIG. 12 and FIG. 13, the vegetable retainer 21 consists of a flat plate-like retainer main body portion 22 whose central portion underside is recessed into a curve-like shape to form a recess 22a, a vegetable retaining portion 23 which protrudes from the recess 22a and which is constructed of a plurality of comb teeth bodies 23a, 23a, . . . for being stuck into a vegetable and the like to retain the vegetable and the like, and sliding portions 24, 24 which extend vertically on both side portions of the retainer main body 22 and which are guided by the left and right frame parts 5, 5 of the cooking utensil main body 2 to slide. When the vegetable retainer 21 is placed on the vegetable cooking utensil 1 to slide thereon, the vegetable retaining portion 23 is formed so that it does not come into contact with the flat blade 3 and the comb blade 4. A plurality of reinforcing ribs 25, 25, . . . which extend in longitudinal and lateral directions are formed on the upper surface of the retainer main body portion 22.

Now, when a cooking person shreds/cooks a vegetable and the like employing the vegetable retainer 21 as shown in FIG. 14, the vegetable retainer 21 is held by a hand 26 of the cooking person, a vegetable and the like which has become small or thin is retained by the vegetable retaining portion 23 of the vegetable retainer 21, the vegetable retainer 21 is slid on the vegetable cooking utensil main body 2, and the vegetable and the like is shredded/cooked. At that time, for example, a thumb 27 and a little finger 28 of the cooking person grasps both side portions of the vegetable retainer 21, and an index finger 29, a middle finger 30, and a third finger 31 are placed near a front end of the vegetable retainer 21. Or the thumb 27, the third finger 31, and the little finger 28 of the cooking person hold both side portions of the vegetable retainer 21, and the index finger 29 and the middle finger 30 are placed near the front end of the vegetable retainer 21.

However, when a vegetable and the like is shredded/cooked employing the vegetable retainer 21, since the index finger 29, the middle finger 30, the third finger 31, and the like are placed near the front end of the vegetable retainer 21 as described above, there is a risk that the tips of the index finger 29, the middle finger 30, the third finger 31, and the like project forwards from the front end of the vegetable retainer 21 during shredding/cooking. In that case, there is the danger that they come into contact with the flat blade and the comb blade 4 and are injured.

### SUMMARY OF THE INVENTION

Thus, a technical problem to be solved occurs in order that a vegetable retainer can be held reliably and that a finger tip does not come into contact with a cooking blade to improve safety performance in a vegetable retainer employed for a vegetable cooking utensil which is constructed in such a manner that a flat blade and a comb blade are provided to shred a vegetable and the like, and it is an object of the present invention to solve this problem.

The present invention is proposed in order to attain the object, and the invention as described in claim 1 is a vegetable retainer employed for a vegetable cooking utensil which is provided with a cooking blade on an approximately central portion in a longitudinal direction of a vegetable cooking utensil main body of a roughly rectangle in a plan view, wherein the vegetable retainer comprises an approximately flat plate-like retainer main body portion whose central portion underside is recessed to form a recess, a vegetable retaining portion which protrudes from the recess and which is constructed of a plurality of comb teeth bodies for being stuck into a vegetable and the like to retain the vegetable and the like, sliding portions which extend vertically on both side portions of the retainer main body portion and which are guided by both side portions of the vegetable cooking utensil main body to slide, and a holding portion which extends upwardly from an upper surface of the retainer main body portion and by which a cooking person holds the vegetable retainer.

According to the invention as described in claim 1, the vegetable retainer can be held reliably by means of the holding portion.

The invention as described in claim 2 is the vegetable retainer for a vegetable cooking utensil as set forth in claim 1, wherein the holding portion comprises a rising portion which extends upwardly near both side portions of the retainer main body portion while extending in a sliding direction and which is formed to have a predetermined height so that the rising portion can be held by a finger of a cooking person and a rising portion which extends upwardly near front and rear ends of the retainer main body portion while respectively extending in a direction along the front and rear ends and which is provided with a notch which is notched at a predetermined size for drainage.

According to the invention as described in claim 2, additionally to the effect of the invention as described in claim 1, the vegetable retainer can be held further reliably, a finger of a cooking person is in contact with the inner surface of the rising portion which extends upwardly extending in a direction along the front and rear ends of the vegetable retainer or it is placed on an inner side thereof so that the finger is prevented from projecting, whereby safety performance can be improved, and drainage of water remaining on the vegetable retainer can be performed by means of the notch.

Further, the invention as described in claim 3 is the vegetable retainer for a vegetable cooking utensil as set forth in claim 1 or 2, wherein the notch is formed at respective two positions on the rising portion near front and rear ends.

According to the invention as described in claim 3, additionally to the effects of the invention as described in claim 1 or 2, water remaining on the vegetable retainer can be drained efficiently from the notches formed at respective two positions on the rising portion.

### BRIEF DESCRIPTION OF THE DRAWINGS

FIG. 1 shows one embodiment of the present invention and is a plan view of a vegetable retainer which is placed on a vegetable cooking utensil.

FIG. 2A is a plan view of the vegetable retainer of FIG. 1.

FIG. 2B is a side elevational view of the vegetable retainer of FIG. 1.

FIG. 3 is a perspective view of the vegetable retainer of FIG. 1.

FIG. 4 is an explanatory view explaining a state where the vegetable retainer of FIG. 1 is held.

FIG. 5 is a plan view of an example of a conventional vegetable cooking utensil.

FIG. 6 is a plan view of a flat blade.

FIG. 7 is a bottom plan view of FIG. 5.

FIG. 8 is a perspective view of a regulating reception plate of FIG. 5.

FIG. 9 is a perspective view of a vegetable cooking utensil main body of FIG. 5.

FIG. 10 is a perspective view of a holding body of FIG. 5.

FIG. 11 shows a prior art example and is a plan view of a vegetable retainer which is placed on a vegetable cooking utensil.

FIG. 12A is a plan view of the vegetable retainer of FIG. 11.

FIG. 12B is a side elevational view of the vegetable retainer of FIG. 11.

FIG. 13 is a perspective view of the vegetable retainer of FIG. 11.

FIG. 14 is an explanatory view explaining a state where the vegetable retainer of FIG. 1 is held.

### DETAILED DESCRIPTION OF THE PREFERRED EMBODIMENT

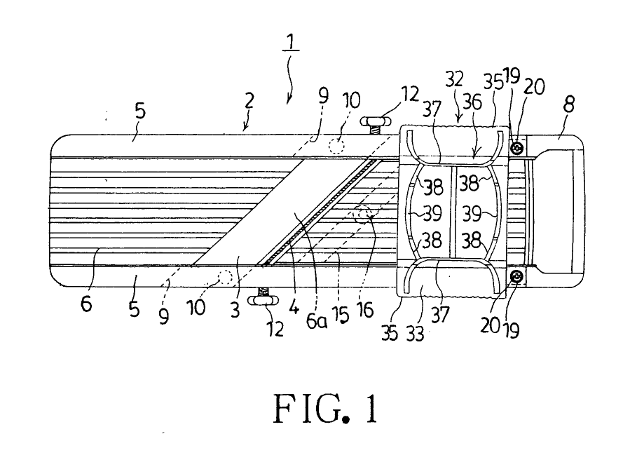

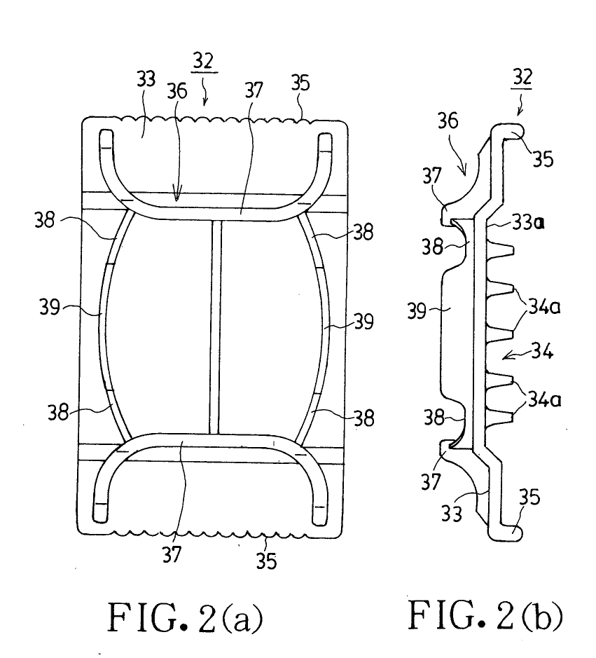

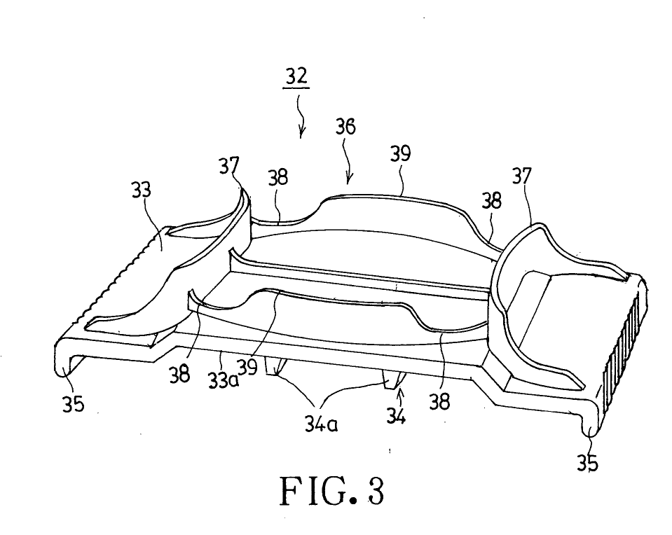

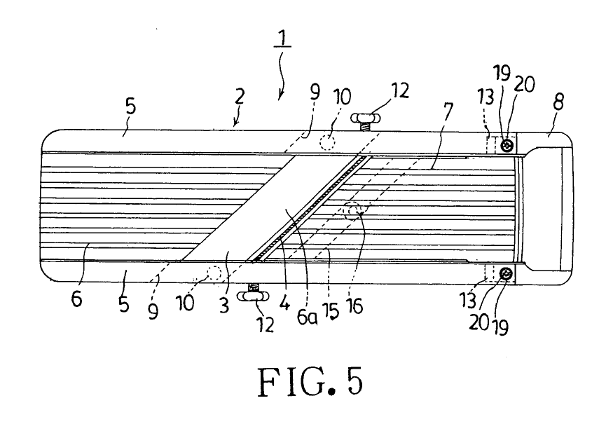

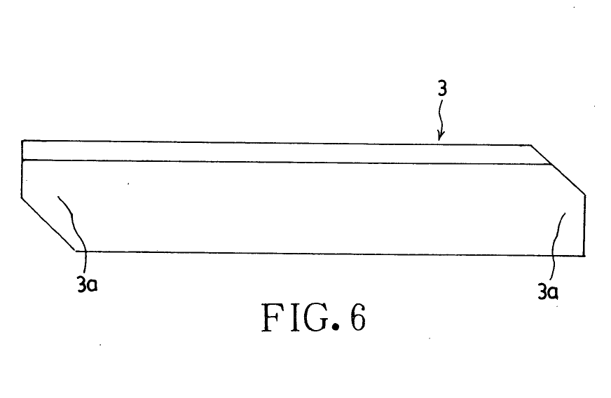

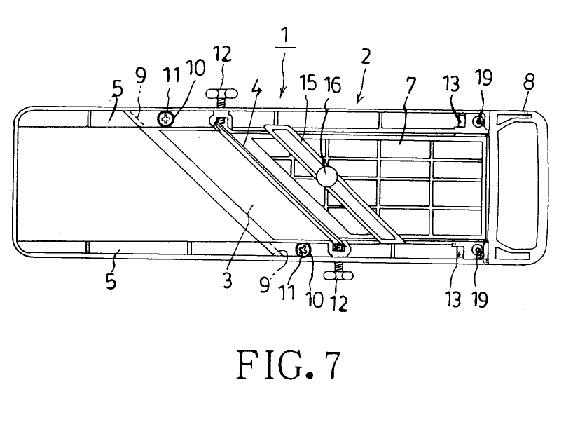

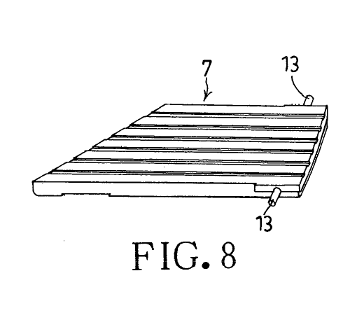

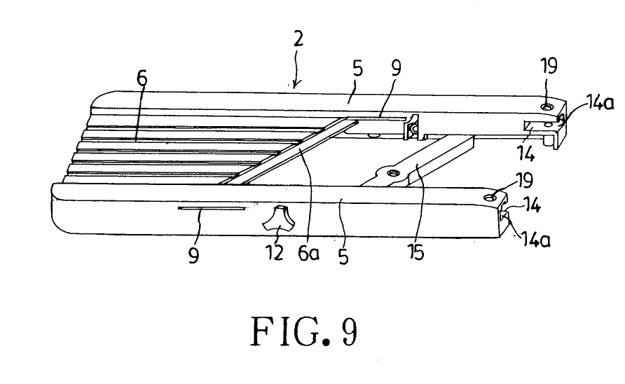

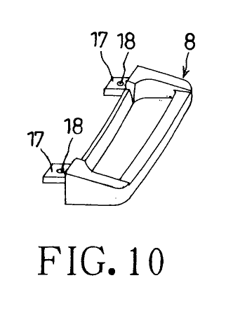

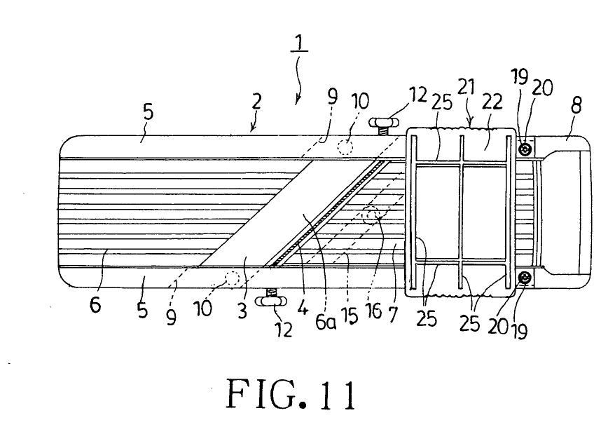

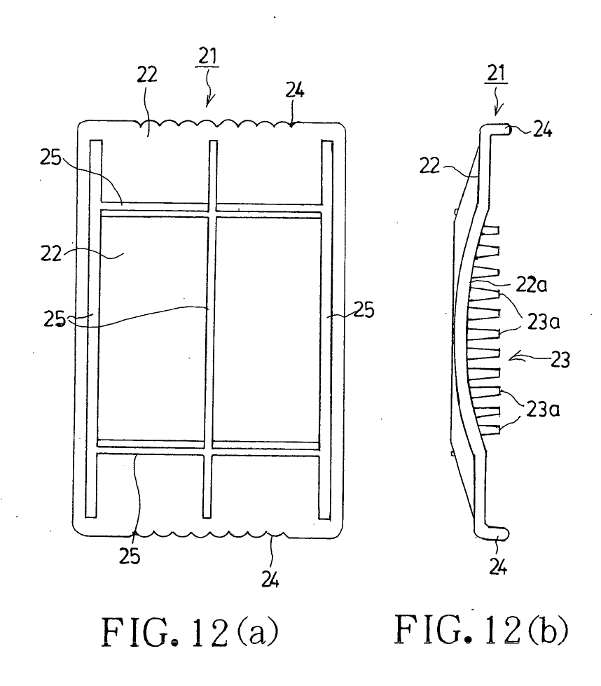

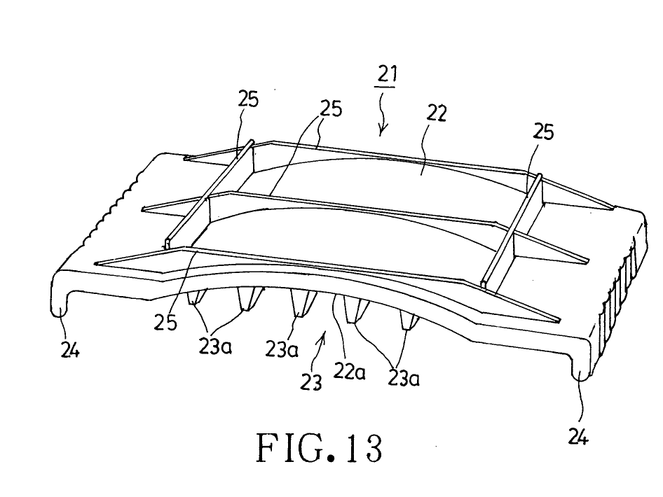

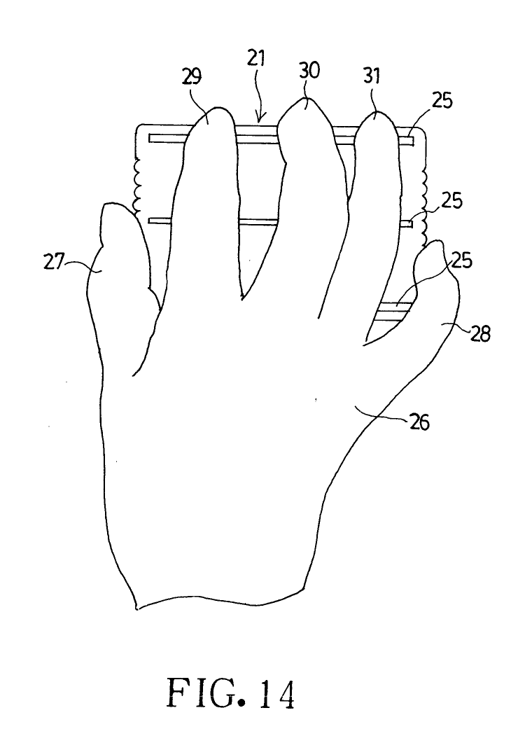

One embodiment of the present invention will be explained in detail below according to FIGS. 1 to 5. Like reference numerals are assigned to the same constructive portions as those of the prior art example, and explanation thereof will be omitted for convenience of explanation. In FIG. 1, the reference numeral 32 denotes a vegetable retainer employed instead of the vegetable retainer (21 in FIG. 11) of the prior art example. As shown in FIG. 2 and FIG. 3, this vegetable retainer 32 consists of a flat plate-like retainer main body portion 33 whose central portion underside is recessed forming a level difference to form a recess 33a, a vegetable retaining portion 34 which protrudes from the recess 33a and which is constructed of a plurality of comb teeth bodies 34a, 34a, . . . for being stuck into a vegetable to retain the vegetable, sliding portions 35, 35 which extend vertically on both side portions of the retainer main body portion 33 and which are guided by the left and right frame parts 5, 5 of the vegetable cooking utensil main body 2 to slide, and a holding portion 36 which extends upwardly from the upper surface of the retainer main body portion 33 and by which a cooking person holds the vegetable retainer 32.

The vegetable retaining portion 34 is formed so that it does not come into contact with the flat blade 3 and the comb blade 4 when the vegetable retainer 32 is placed on the vegetable cooking utensil 1 to slide thereon.

The holding portion 36 consists of rising portions 37 which extend upwardly near both side portions of the retainer main body portion 33 while extending in a sliding direction and which are formed to have a predetermined height so that they can be held by fingers of a cooking person and rising portions 39, 39 which extend upwardly near front and rear ends of the retainer main body portion 33 while respectively extending in directions along the front and rear ends and each of which is provided with two notches 38, 38 which are notched at a predetermined size for drainage. The rising portions 37, 37, 39,39 are formed symmetrically and also have the function of reinforcing ribs.

The rising portions 37, 37 are constructed in such a way that both ends of the rising portions 37, 37 which extend upwardly near the both side portions of the retainer main body portion 33 are bent outwardly so that fingers of a cooking person do not come off and they can be held reliably.

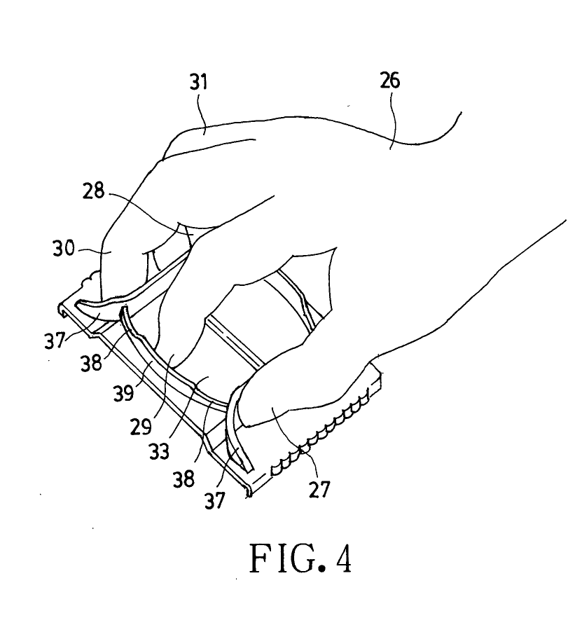

When a cooking person shreds/cooks a vegetable and the like employing the vegetable retainer 32, for example, as shown in FIG. 4, a thumb 27, a middle finger 30, a third finger 31, and a little finger 28 of the cooking person hold the outer surfaces of the rising portions 37, 37 which extend upwardly near the both side portions of the retainer main body portion 33. An index finger 29 is in contact with inner surface of the rising portion 39 which extends upwardly near the front end of the retainer main body portion 33 or is placed on an inner side.

When a vegetable and the like is shredded/cooked employing the vegetable retainer 32, the vegetable retainer 32 can be held reliably by the thumb 27, the middle finger 30, the third finger 31, and the little finger 28 of the cooking person. At the same time, the index finger 29 is in contact with the inner surface of the rising portion 39 or is placed on an inner side, and it does not project from the front end of the vegetable retainer 32, so that there comes no risk that the index finger 29 comes into contact with the flat blade 3 and the comb blade 4, whereby safety performance is improved. Since the rising portions 37, 37, 39, 39 are formed symmetrically, a left-handed cooking person also can use the vegetable retainer 32, and in that case also, safety performance is ensured similarly.

Various changes may be made in the present invention without departing from the spirit and scope of the invention, and as a matter of course, the present invention extends those which are changed therein.

1. A vegetable retainer employed for a vegetable cooking utensil which is provided with a cooking blade on an approximately central portion in a longitudinal direction of a vegetable cooking utensil main body of a roughly rectangle in a plan view, said vegetable retainer comprising an approximately flat plate-like retainer main body portion whose central portion underside is recessed to form a recess, a vegetable retaining portion which protrudes from the recess and which is constructed of a plurality of comb teeth bodies for being stuck into a vegetable and the like to retain the vegetable and the like, sliding portions which extend vertically on both side portions of the retainer main body portion and which are guided by both side portions of the vegetable cooking utensil main body to slide, and a holding portion which extends upwardly from an upper surface of the retainer main body portion and by which a cooking person holds the vegetable retainer.

2. The vegetable retainer for a vegetable cooking utensil as set forth in claim 1, wherein the holding portion comprises a rising portion which extends upwardly near both side portions of the retainer main body portion while extending in a sliding direction and which is formed to have a predetermined height so that the rising portion can be held by a finger of a cooking person and a rising portion which extends upwardly near front and rear ends of the retainer main body portion while respectively extending in a direction along the front and rear ends and which is provided with a notch which is notched at a predetermined size for drainage.

3. The vegetable retainer for a vegetable cooking utensil as set forth in claim 1 or 2, wherein the notch is formed at respective two positions on the rising portion near front and rear ends.
